(19) United States
(12) Patent Application Publication
(10) Pub. No.: US 2011/0231763 A1
(43) Pub. Date: Sep. 22, 2011

(54) ELECTRONIC APPARATUS AND IMAGE PROCESSING METHOD

(75) Inventors: Tomonori Sakaguchi, Ome-shi (JP); Kouetsu Wada, Nishitama-gun (JP); Kohei Momosaki, Mitaka-shi (JP); Kenichi Tabe, Ome-shi (JP)

(73) Assignee: KABUSHIKI KAISHA TOSHIBA, Tokyo (JP)

(21) Appl. No.: 13/007,386

(22) Filed: Jan. 14, 2011

(30) Foreign Application Priority Data
Mar. 16, 2010 (JP) 2010-059818

(51) Int. Cl. G06F 3/048

(52) U.S. Cl. 715/720

(57) ABSTRACT

An electronic apparatus includes a first playback module, a moving image information data creating module, a display module, and a second playback module.

The first playback module plays back a moving image in which one or more still images used for the moving image are respectively displayed at predetermined display timings. The moving image information data creating module creates moving image information data indicating respective locations where the one or more still images are stored and indicating the predetermined display timings. The display module displays a playback history list of moving images played back by the first playback module. The second playback module plays back a moving image selected from the playback history list based on moving image information data corresponding to the selected moving image.

### CROSS-REFERENCE TO RELATED APPLICATIONS

This application is based upon and claims the benefit of priority from Japanese Patent Application No. 2010-059818, filed Mar. 16, 2010; the entire contents of which are incorporated herein by reference.

### FIELD

Embodiments described herein relate generally to an electronic apparatus which displays moving images, and an image processing method applied to the apparatus.

### BACKGROUND

In recent years, image playback apparatuses referred to as digital photo frames have been become widespread. Digital photo frames have a function of successively displaying a plurality of still images stored in, for example, a card-type storage medium, at predetermined time intervals. For example, personal computers and digital cameras also generally have a function of successively displaying a plurality of still images at predetermined time intervals.

Jpn. Pat. Appln. KOKAI Pub. No. 2005-340987 discloses a slideshow creation apparatus which creates a slideshow by using a plurality of images. In the slideshow creation apparatus, a slideshow can be created by using a template suitable for images selected by the user.

In the meantime, there are cases where data to successively display one or more still images is stored as a moving image data file. However, a number of moving image data files may be generated from still images, and the size of the moving image data files may be enormous.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary perspective view illustrating an external appearance of an electronic apparatus according to an embodiment.

FIG. 2 is an exemplary block diagram illustrating a system configuration of the electronic apparatus of the embodiment.

FIG. 3 is an exemplary block diagram illustrating a functional structure of a moving image player application program executed by the electronic apparatus of the embodiment.

FIG. 4 is an exemplary diagram illustrating an example of content information used by the moving image player application program executed by the electronic apparatus of the embodiment.

FIG. 5 is an exemplary diagram illustrating an example of an intermediate file used by the moving image player application program executed by the electronic apparatus of the embodiment.

FIG. 6 is an exemplary diagram illustrating an example of playback history information used by the moving image player application program executed by the electronic apparatus of the embodiment.

FIG. 7 is an exemplary diagram illustrating an example of an interactive photomovie creation screen, which is displayed by the moving image player application program executed by the electronic apparatus of the embodiment.

FIG. 8 is an exemplary diagram illustrating an example of a photomovie playback history list screen, which is displayed by the moving image player application program executed by the electronic apparatus of the embodiment.

FIG. 9 is an exemplary flowchart illustrating an example of a process of moving image playback processing executed by the electronic apparatus of the embodiment.

FIG. 10 is an exemplary flowchart illustrating an example of a process of interactive playback processing executed by the electronic apparatus of the embodiment.

### DETAILED DESCRIPTION

Various embodiments will be described hereinafter with reference to the accompanying drawings.

In general, according to one embodiment, an electronic apparatus includes a first playback module, a moving image information data creating module, a display module, and a second playback module. The first playback module plays back a moving image in which one or more still images are respectively displayed at predetermined display timings. The moving image information data creating module creates moving image information data which indicates locations where the one or more still images used for the moving image are stored and the predetermined display timings. The display module displays a playback history list of moving images played back by the first playback module. The second playback module plays back a moving image selected from the playback history list, based on moving image information data corresponding to the selected moving image.

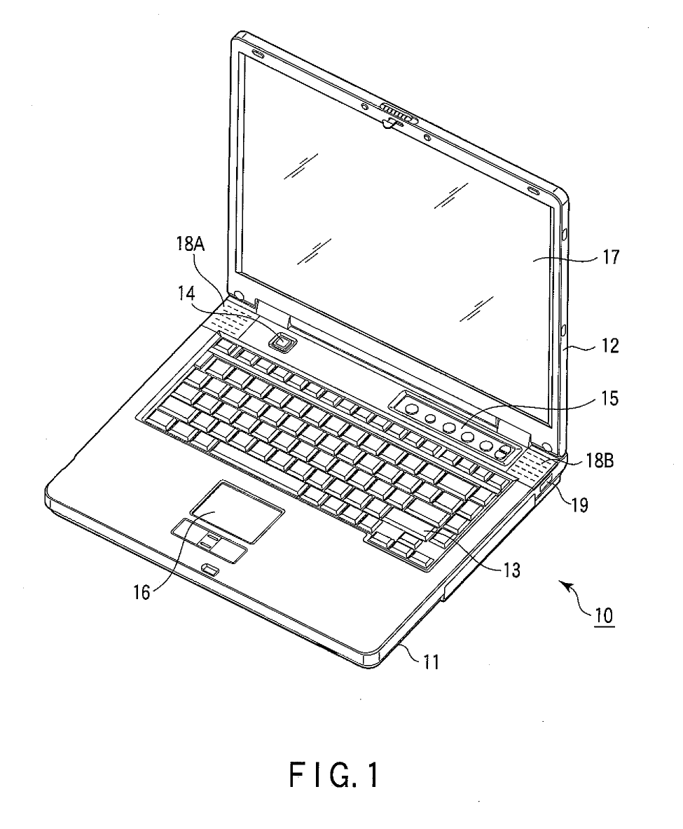

FIG. 1 is a perspective view illustrating an external appearance of an electronic apparatus according to an embodiment. The electronic apparatus is realized, for example, as a notebook-type personal computer 10. As shown in FIG. 1, the computer 10 includes a computer main body 11 and a display unit 12. A display device including a liquid crystal display (LCD) 17 is built in the display unit 12. The display unit 12 is attached to the computer main body 11 such that the display unit 12 is rotatable between an open position where the top surface of the computer main body 11 is exposed, and a closed position where the top surface of the computer main body 11 is covered.

The computer main body 11 has a thin box-shaped housing. A keyboard 13, a power button 14 for powering on/off the computer 10, an input operation panel 15, a touchpad 16, and speakers 18A and 18B are disposed on the top surface of the housing of the computer main body 11. Various operation buttons are provided on the input operation panel 15.

The right side surface of the computer main body 11 is provided with a USB connector 19 for connection to a USB cable or a USB device of, e.g. the universal serial bus (USB) 2.0 standard. Further, the rear surface of the computer main body 11 is provided with an external display connection terminal (not shown) which supports, e.g. the high-definition multimedia interface (HDMI) standard. This external display connection terminal is used in order to output a digital video signal to an external display.

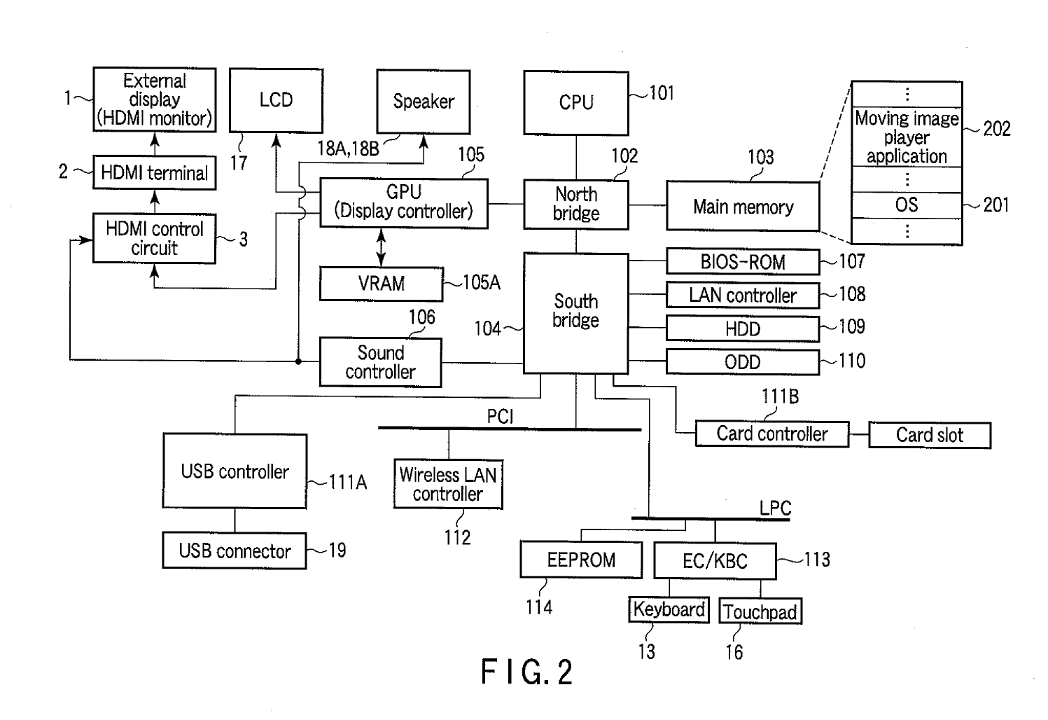

FIG. 2 shows the system configuration of the computer 10.

The computer 10, as shown in FIG. 2, may comprise a central processing unit (CPU) 101, a north bridge 102, a main memory 103, a south bridge 104, a graphics processing unit (GPU) 105, a video random access memory (VRAM) 105A, a sound controller 106, a basic input/output system-read only memory (BIOS-ROM) 107, a local area network (LAN) controller 108, a hard disk drive (HDD) 109, an optical disc drive (ODD) 110, a USB controller 111, a wireless LAN controller 112, an embedded controller/keyboard controller (EC/KBC) 113, and an electrically erasable programmable ROM (EEPROM) 114.

The CPU 101 is a processor which controls operations of various components in the computer 10. The CPU 101 executes an operating system (OS) 201 and various application programs such as a moving image player application program 202, which are loaded from the HDD 109 into the main memory 103. The moving image player application program 202 is software which plays back various digital contents stored in, for example, the HDD 109. The moving image player application program 202 has a photomovie (moving image) playback function. The photomovie playback function is a function of creating and playing back (displaying) a photomovie, by using digital contents, such as photographs, stored in the HDD 109 or the like. In addition, the photomovie playback function includes a function of creating moving image information data (intermediate file) which indicates respective positions (file paths), where one or more still images (photographs) to be used for a photomovie are stored, and display timing at which each of the still images is displayed. The moving image player application program 202 plays back a moving image (movie) in which each of one or more still images is displayed at predetermined display timing, and displays the moving image on the screen (LCD 17), based on the moving image information data. The photomovie is also referred to as an intelligent slideshow.

In addition, the CPU 101 also executes a BIOS stored in the BIOS-ROM 107. The BIOS is a program for hardware control.

The north bridge 102 is a bridge device which connects a local bus of the CPU 101 and the south bridge 104. The north bridge 102 includes a memory controller which access-controls the main memory 103. The north bridge 102 also has a function of executing communication with the GPU 105 via, e.g. a PCI EXPRESS serial bus.

The GPU 105 is a display controller which controls the LCD 17 used as a display monitor of the computer 10. A display signal, which is generated by the GPU 105, is sent to the LCD 17. In addition, the GPU 105 can send a digital video signal to an external display device 1 via an HDMI control circuit 3 and an HDMI terminal 2.

The HDMI terminal 2 is the above-described external display connection terminal. The HDMI terminal 2 is capable of sending a non-compressed digital video signal and a digital audio signal to the external display device 1, such as a TV, via a single cable. The HDMI control circuit 3 is an interface for sending a digital video signal to the external display device 1, which is called “HDMI monitor”, via the HDMI terminal 2.

The south bridge 104 controls devices on a peripheral component interconnect (PCI) bus and devices on a low pin count (LPC) bus. The south bridge 104 comprises an integrated drive electronics (IDE) controller for controlling the HDD 109 and ODD 110. The south bridge 104 also has a function of executing communication with the sound controller 106.

The sound controller 106 is a sound source device and outputs audio data, which is to be played back, to the speakers 18A and 18B or the HDMI control circuit 3. The LAN controller 108 is a wired communication device which executes wired communication of, e.g. the IEEE 802.3 standard. On the other hand, the wireless LAN controller 112 is a wireless communication device which executes wireless communication of, e.g. the IEEE 802.11 g standard. The USB controller 111A executes communication with an external device which supports, e.g. the USB 2.0 standard (the external device is connected via the USB connector 19). For example, the USB controller 111A executes communication when taking in digital images, which are managed by a digital camera that is an external device, and to store the digital images in the HDD 109. The card controller 111B executes writing and reading of data for a memory card such as an SD card which is inserted into a card slot provided in the computer main body 11.

The EC/KBC 113 is a one-chip microcomputer in which an embedded controller for power management and a keyboard controller for controlling the keyboard 13 and touchpad 16 are integrated. The EC/KBC 113 has a function of powering on/off the computer 10 in accordance with the user's operation of the power button 14.

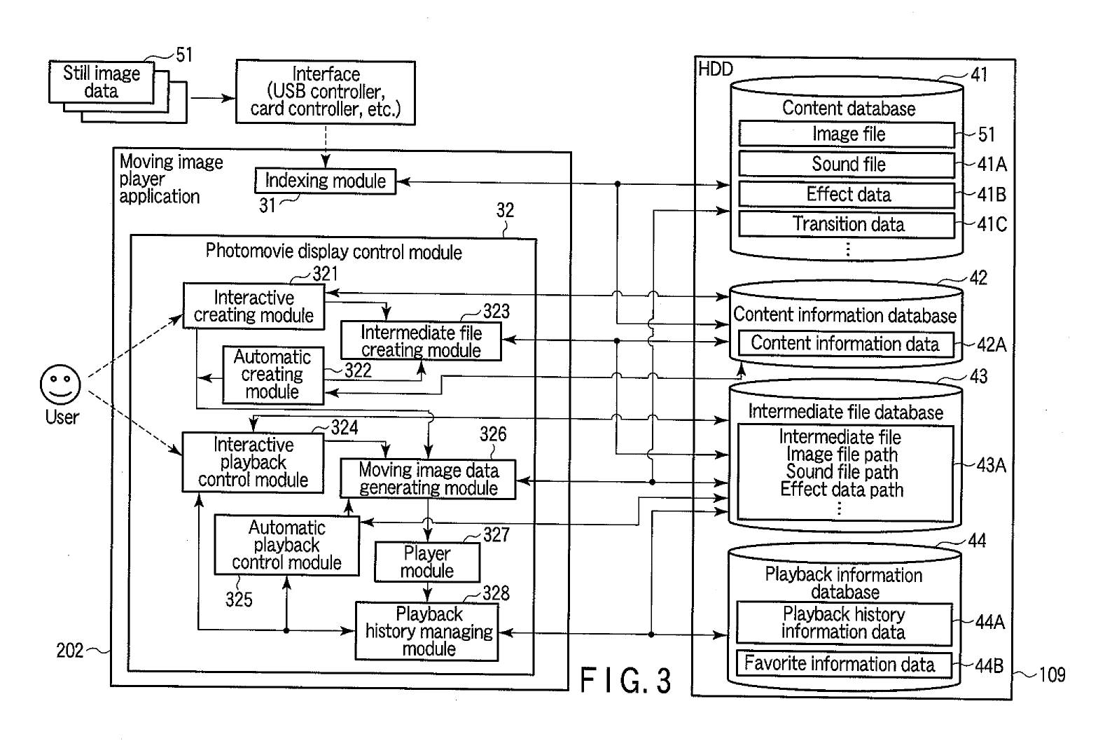

Next, with reference to FIG. 3, a description of a functional structure of the moving image player application program 202 which runs on the computer 10 is given. In this embodiment, an example of a structure to realize the photomovie function is explained, among functions of the moving image player application program 202. The photomovie function can be applied to not only still image data 51 stored in the HDD 109, but also still image data 51 read from an external device (digital camera, memory card) through the interface module (such as the USB controller 111A and the card controller 111B described above). The still image data 51 illustrated in FIG. 3 may be image frames extracted from moving image data, as well as photographic data.

As illustrated in FIG. 3, the moving image player application program 202 includes an indexing module 31 and a photomovie display control module 32.

The indexing module 31 executes indexing processing to generate content information data 42A corresponding to respective still images 51. The content information data 42A is used for retrieving a target still image from still images (still image data) 51 stored in a content database 41 (HDD 109).

In the indexing processing, for example, face detection processing is performed to detect face images from the still images 51. For a still image including a plurality of face images, each of the face images is detected. Face image detection can be performed by analyzing features of a still image and retrieving areas having features similar to prepared samples of face image features. The samples of face image features are feature data calculated by statistically processing face image features of a number of people. By face detection processing, the position (coordinates), size, and frontal degree of each face image included in a still image are detected.

In addition, the indexing module 31 may classify the detected face images. The indexing module 31 classifies face images, which are detected from the still images 51, into groups of face images which are estimated as faces of the identical person. The indexing module 31 may also identify a person corresponding to the detected face images. In such a case, the indexing module 31 determines whether the detected face image is the person by using, for example, a sample of face image features of the person to be identified.

The indexing module 31 also executes event detection processing of estimating an event based on objects included in a still image and the taken date of the still image. For example, the indexing module 31 determines an event estimated for a still image, based on correspondence between the dates of events such as a birthday and Christmas and the taken date of the still image.

The indexing module 31 may also execute grouping processing of grouping still images based on the taken dates. For example, when the difference in the taken date and time between two still images 51 whose taken dates and times are successive is smaller than a threshold value, the indexing module 31 classifies the two still images 51 into the same group. When the difference in the taken date and time is equal to or larger than the threshold value, the indexing module 31 classifies the two still images 51 into different groups. In addition, when still images 51 are a plurality of frame images included in moving image data, the indexing module 31 detects, for example, a scene-change point before and after which the features of the images greatly change, and groups each scene as one section. As described above, the indexing module 31 determines groups to which still images belong.

The indexing module 31 stores still images 51, which are read from an external device via the interface module, in the content database 41. In addition, the indexing module 31 subjects the stored still images 51 to the above indexing processing. The indexing module 31 stores content information data 42A in the content information database 42. The content information data 42A includes face image information, event information, and group information obtained by the indexing processing.

The indexing module 31 may perform indexing processing for still images 51 newly stored in a predetermined directory in the HDD 109 by monitoring the directory. The indexing module 31 also stores content information data 42A in the content information database 42. The content information data includes face image information, event information, and group information, which are obtained by the indexing processing performed for the still images 51 in the directory. The predetermined directory corresponds to, for example, the content database 41.

The content database 41 is a storage area allocated in the HDD 109, and stores content data such as still image data 51, sound data 41A, effect data 41B, and transition data 41C. The sound data 41A includes data such as music and sound effects used as BGM of photomovies. The effect data 41B includes data for subjecting still images used for photomovies to effects such as zoom, rotation, slide-in/out, superimposing images such as frame border, and fade in/out. The transition data 41C includes transition data of zoom, rotation, slide-in/out, superimposing images such as frame border, and fade in/out, which are used when screens (still images) are switched in a photomovie. The content database 41 can also store representative thumbnail images of respective photomovies, and face images of people appearing in the photomovies.

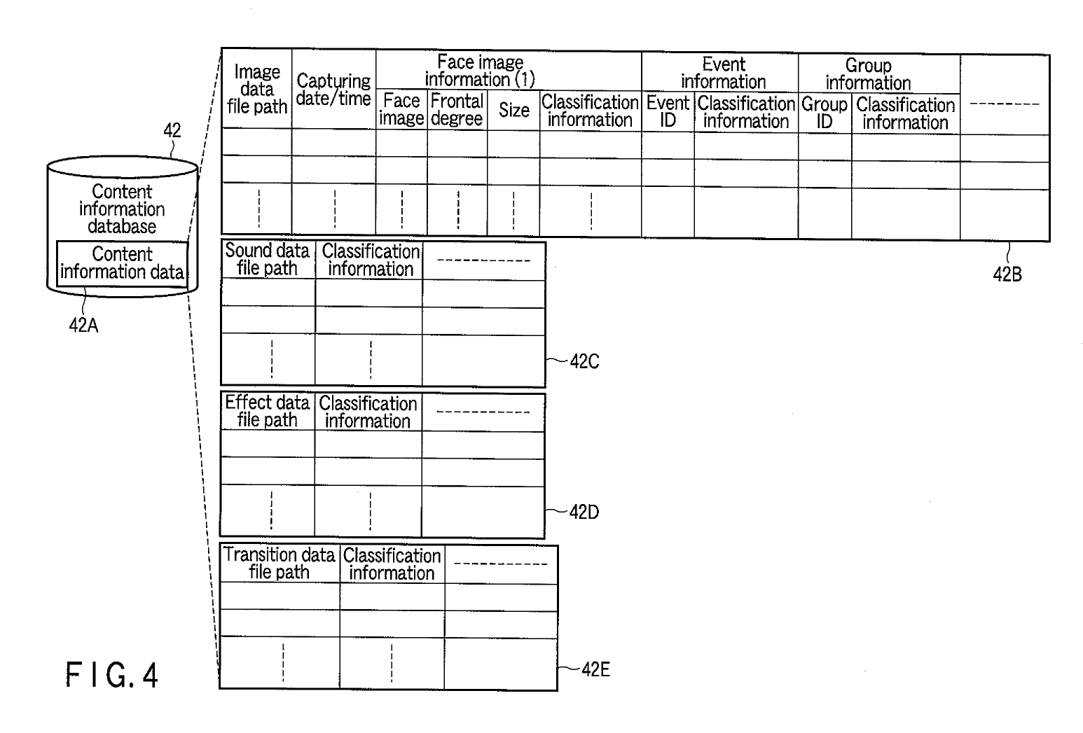

The content information database 42 is a storage area allocated in the HDD 109, and stores content information data 42A. FIG. 4 illustrates an example of a structure of the content information data 42A.

The content information data 42A includes image information data 42B, sound information data 42C, effect information data 42D, and transition information data 42E. The image information data 42B includes an image data file path, a taken date, face image information, event information, and group information of each still image 51.

The image data file path indicates a file path (path) of a still image 51.

The taken date is time information indicating the taken date and time of a still image 51. When the still images 51 are frame images included in moving image data, the taken date (time stamp information) of each frame is calculated based on the taken date and time of the moving image data. Specifically, the taken date and time of each frame is calculated based on the taken date and time of the head frame of the moving image data and respective frame numbers of the frames.

The face image information includes information relating to a face image of a person appearing in a still image 51. The face image information includes a face image extracted by the indexing module 31, and the frontal degree, size, and classification information of the face image. The frontal degree indicates the degree to which the face is photographed from the front. The size indicates the size of the extracted face image. The classification information indicates information of a group of face images estimated as the identical person by the indexing module 31. The classification information may indicate information of a person identified based on the face image. The face image information items are recorded for respective people included in the still image 51.

The event information indicates information of an event corresponding to a still image 51, detected by event detection processing by the indexing module 31. The event information includes an event ID and classification information. The event ID is identification information which is uniquely allocated to the event. The event ID may be a name of the event. The classification information is information indicating e.g. a category of the event and an attribute of the event.

The group information indicates information of a group into which still images 51 are classified by grouping processing performed by the indexing module 31. The group information includes a group ID and classification information. The group ID is identification information which is uniquely allocated to the group. The group ID may be a name of the group. The classification information is information indicating e.g. a category of the group and an attribute of the group.

The sound information data 42C includes a sound data file path and classification information of each sound data item 41A. The sound data file path indicates a file path of each sound data item 41A. The classification information is information indicating a category of the sound data item 41A and an attribute of the sound data item 41A.

The effect information data 42D includes an effect data file path and classification information for each effect data item 41B. The effect data file path indicates a file path of each effect data item 41B. The classification information is information indicating a category of the effect data item 41B and an attribute of the effect data item 41B.

The transition information data 42E includes a transition data file path and classification information for each transition data item 41C. The transition data file path indicates a file path of each transition data item 41C. The classification information is information indicating a category of the transition data item 41C and an attribute of the transition data item 41C.

By using the content information data 42A, it is possible to determine, for each of the still images 51, whether a face image is included in the still image or not, the number of face images included in the still image, whether there is any still image corresponding to a designated event or not, and to which group the still image belong. In other words, by using the content information data 42A, it is possible to smoothly retrieve a still image 51 including a target person, and a still image 51 including a target person and corresponding to a specific event, from one or more still images 51 stored in the HDD 109.

By using the content information data 42A, the photomovie display control module 32 selects one or more still images satisfying predetermined (specified) conditions, from one or more still images 51 stored in the content database 41. Then, the photomovie display control module 32 creates and plays back (displays) a photomovie, by using the selected one or more still images.

The photomovie display control module 32 includes an interactive creation module 321, an automatic creation module 322, an intermediate file creation module 323, an interactive playback control module 324, an automatic playback control module 325, a moving image data generating module 326, a player module 327, and a playback history managing module 328.

The photomovie display control module 32 has two functions of creating a photomovie which include a function of interactively creating a photomovie (interactive creation mode), and a function of automatically creating a photomovie (automatic creation mode). The function of interactively creating a photomovie is a function in which the user creates a photomovie by using, for example, one or more still images satisfying conditions designated with an operation screen (GUI). The function of automatically creating a photomovie is a function of creating a photomovie by using, for example, one or more still images including newly-arrived still images, still images relating to the date of creation, and/or still images selected at random.

The photomovie display control module 32 also has two functions of playing back a photomovie which include a function of interactively playing back a photomovie (interactive playback mode), and a function of automatically playing back a photomovie (automatic playback mode). The function of interactively playing back a photomovie is a function in which the user plays back a photomovie selected by using, for example, an operation screen (GUI). The function of automatically playing back a photomovie is a function of playing back, for example, a newly-arrived photomovie, a photomovie relating to the date of playback, or a photomovie selected at random.

The following is explanation of processing for creating a photomovie in the interactive creation mode. The interactive creation module 321 determines conditions for creating a photomovie, in accordance with instructions by the user. First, the interactive creation module 321 selects one or more still images designated by the user from the still images 51. The interactive creation module 321 may select one or more still images satisfying conditions such as the event, taken date, and group designated by the user from the still images 51. In addition, the interactive creation module 321 may select one or more still images, the person, event, taken date, or group of which is the same as or relates to the still image designated by the user, from the still images 51.

Next, the interactive creation module 321 selects sound data, effect data, and transition data designated by the user from the sound data 41A, the effect data 41B, and the transition data 41C, respectively. The interactive creation module 321 may select sound data, effect data, and transition data having classification information and attributes corresponding to a style (such as “ceremonial” and “happy”) designated by the user. The interactive creation module 321 may select sound data, effect data, and transition data having classification information and attributes suitable for one or more still images selected in accordance with instructions by the user. It is possible to select a plurality of sound data items, a plurality of effect data items, and a plurality of transition data items. By selecting a plurality of data items, for example, it is possible to provide one or more still images with different effects in one photomovie, use different transitions for respective changes of still images, and change sound data used as BGM in the middle of a photomovie. The interactive creation module 321 may further select still images, which are suitable for the style designated by the user and sound data used as BGM, among the selected images.

The interactive creation module 321 determines sound parameters indicating timing at which the selected sound data is output, effect parameters indicating still images, which are subjected to the selected effect data, and timing at which the selected effect data is subjected, and transition parameters indicating a change of still images (still images before and after the change) which the selected transition data is subjected to and timing at which the selected transition data is subjected. The effect parameters and the transition parameters may include the position and the magnification of zoom, the position and the angle of rotation, the speed of slide-in/out, the position where an image such as a frame border is superimposed, the size of the superimposed image, and the time of fade in/out. For example, values set by the user by using the operation screen are used as these parameters. It is also possible to use parameters corresponding to a style designated by the user.

The interactive creation module 321 may select proper effect data, transition data and sound data, in accordance with face information (face image information) included in each of one or more still images and obtained by face detection processing. The interactive creation module 321 may set motion information (effect parameters, transition parameters, and sound parameters) to attract attention to faces included in the still images.

The interactive creation module 321 outputs respective file paths of the selected one or more still images, sound data items, effect data items, and transition data items, and parameters (sound parameters, effect parameters, and transition parameters) corresponding to the respective data items to the intermediate file creating module 323.

The intermediate file creating module 323 creates an intermediate file 43A, using respective file paths of one or more still images, sound data items, effect data items, and transition data items, and parameters corresponding to the respective data items output from the interactive creation module 321. The intermediate file 43A includes moving image information data indicating respective locations (file paths) where one or more still images selected from the still images 51 are stored, and display timing at which each of the still images is displayed on the screen. More specifically, the intermediate file 43A includes file paths indicating respective locations of one or more still images, a file path and effect parameters of effect data to which the still images are subjected, a file path and transition parameters of transition data which is used when still images are changed, and a file path and sound parameters of sound data output together with display of the still images. The intermediate file 43A is described in, for example, the XML form.

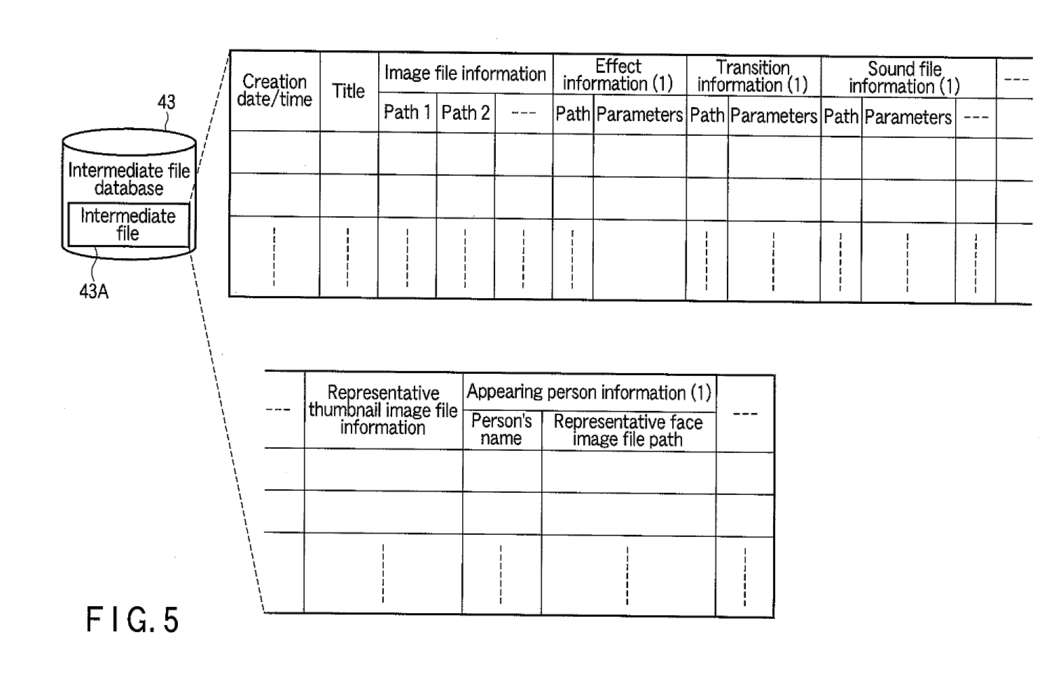

FIG. 5 illustrates an example of a structure of the intermediate file 43A. The intermediate file 43A includes information such as the creation date, a title, image file information, effect information, transition information, sound file information, representative thumbnail image file information, and appearing person information of a photomovie.

The creation date is time information indicating the date and time of creation of the photomovie. The title is a name such as a title of the photomovie.

The image file information is information indicating respective file paths (paths) of one or more still images 51 (image files) included in the photomovie. The effect information includes a file path indicating the effect data 41B, and effect parameters which are used for subjecting the still images to an effect. The transition information includes a file path indicating the transition data 41C, and transition parameters which are used for subjecting still images to a transition when the still images are switched. The sound file information includes a file path of sound data 41 (sound data file) included in the photomovie, and sound parameters indicating timing at which the sound data is output in the photomovie. The representative thumbnail image file information is information indicating a file path of a representative thumbnail image of the photomovie. The appearing person information is information indicating a name of a person appearing in the photomovie, and a file path of a face image of the person. The intermediate file 43A may not be a data file, but data (record) stored in a table in the database.

The intermediate file creating module 323 stores the created intermediate file 43A in the intermediate file database 43. In the items “title”, “representative thumbnail image file information”, and “appearing person information” included in the intermediate file 43A, information designated by the user may be described, or information determined based on the still images used for the photomovie may be described.

The moving image player application 202 plays back moving image data based on the above intermediate file 43A, in response to a request to play back a photomovie. Specifically, moving image data to play back a photomovie is created, based on an intermediate file 43A corresponding to the photomovie (that is, describing the structure of the photomovie), when playback of the photomovie is requested. Therefore, the storage device such as the HDD 109 stores the intermediate file 43A corresponding to the photomovie, still image data 51, sound data 41A, effect data 41B, and transition data 41C which are used for the photomovie, and it is unnecessary to store the moving image data itself having a large data quantity. Thus, using an intermediate file 43A corresponding to a photomovie can reduce a data quantity for the photomovie. That is, the intermediate file 43A does not include actual data such as image data and sound data, but includes link information to these data, and thus it is possible to reduce a data quantity corresponding to a photomovie.

Next, processing for creating a photomovie in the automatic creation mode will now be explained. First, the automatic creation module 322 selects one or more still images used for a photomovie from the still images 51. The automatic creation module 322 selects, for example, newly-arrived still images, still images relating to the date of creation, and/or still images selected at random, as still images used for the photomovie. The automatic creation module 322 also selects sound data, effect data, and transition data suitable for the selected still images.

The automatic creation module 322 determines sound parameters, effect parameters and transition parameters. The sound parameters indicate timing at which the selected sound data is output. The effect parameters indicate still images, which are subjected to the selected effect data, and timing when the still images are subjected to the selected effect data. The transition parameters indicate a change of still images (still images before and after the change) which is subjected to the selected transition data and timing when the still images are subjected to the selected transition data. The effect parameters and the transition parameters may include the position and the magnification of zoom, the position and the angle of rotation, the speed of slide-in/out, the position where an image such as frame border is superimposed, the size of the superimposed image, and the time of fade in/out. For example, values suitable for the taken date, face image information, event information, and group information of the selected one or more still images are set as these parameters.

The automatic creation module 322 may select proper effect data, transition data, and sound data in accordance with face information (face image information) included in each of one or more still images obtained by face detection processing. The automatic creation module 322 may set motion information (effect parameters, transition parameters, and sound parameters) to attract attention to faces included in the still images.

The automatic creation module 322 outputs respective file paths of the selected one or more still images, sound data items, effect data items, and transition data items, and parameters (sound parameters, effect parameters, and transition parameters) corresponding to the respective data items to the intermediate file creating module 323.

The intermediate file creating module 323 creates an intermediate file 43A, using respective file paths of one or more still images, sound data items, effect data items, and transition data items, and parameters corresponding to the respective data items output from the automatic creation module 322. The intermediate file 43A includes moving image information data indicating respective locations (file paths) where one or more still images selected from the still images 51 are stored, and display timing at which each of the still images is displayed on the screen. More specifically, the intermediate file 43A includes file paths indicating respective locations of one or more still images, a file path and effect parameters of effect data to which the still images are subjected, a file path and transition parameters of transition data which is used when still images are changed, and a file path and sound parameters of sound data output together with display of the still images. The intermediate file 43A has the same structure as described above with reference to FIG. 4. The intermediate file creating module 323 stores the created intermediate file 43A in the intermediate file database 43. In the items “title”, “representative thumbnail image file information”, and “appearing person information” included in the intermediate file 43A, information designated by the user may be described, or information determined based on the still images used for the photomovie may be described.

The automatic creation module 322 may automatically (successively) create photomovies while the moving image player application 202 is operated. Specifically, the moving image player application 202 may automatically (successively) create photomovies when it operates in the automatic creation mode.

Next, processing of playing back a photomovie in the interactive playback mode will now be explained. The interactive playback control module 324 plays back a photomovie selected by the user. Specifically, the interactive playback control module 324 displays a list of created photomovies and a list of playback history of photomovies on the screen. In the list of photomovies, for example, titles of the photomovies, representative thumbnail images of the photomovies, and names and face images of appearing people of the photomovies are displayed.

In response to selection of a photomovie from the list, the interactive playback control module 324 reads an intermediate file 43A corresponding to the selected photomovie from the intermediate file database 43. Then, the interactive playback control module 324 outputs the read intermediate file 43A to the moving image data generating module 326.

The moving image data generating module 326 generates moving image data, based on the intermediate file 43A output from the interactive playback control module 324. Specifically, the moving image data generating module 326 generates moving image data, based on image file information, effect information, transition information, and sound file information included in the intermediate file 43A.

First, the moving image data generating module 326 reads still image data 51 from the content database 41, based on respective file paths of one or more still images included in the image file information. In the same manner, the moving image data generating module 326 reads corresponding effect data 41B, transition data 41C, and sound data 41A from the content database 41, based on a file path of effect data included in the effect information, a file path of transition data included in the transition information, and a file path of sound data included in the sound file information.

Then, the moving image data generating module 326 generates moving image data by subjecting the read still image data 51 to an effect based on effect parameters included in the effect information, and subjecting the still image data 51 to transition based on transition parameters included in the transition information. As described above, the effect parameters and the transition parameters may include the position and the magnification of zoom, the position and the angle of rotation, the speed of slide-in/out, the position where an image such as a frame is superimposed, the size of the superimposed image, and the time of fade in/out. The moving image data generating module 326 generates moving image data by which still image data 51 subjected to an effect and transition are displayed, based on values designated by such parameters.

In addition, the moving image data generating module 326 combines sound data with the moving image data, based on sound parameters included in the sound file information. The moving image data generating module 326 generates moving image data combined with sound data, based on values designated by timing information and sound volume information included in the sound parameters.

Next, processing of playing back a photomovie in the automatic playback mode will now be explained. The automatic playback control module 325 selects, for example, a newly-arrived photomovie, a photomovie relating to the date of creation, or a photomovie selected at random, as photomovie to be played back. The automatic playback control module 325 reads an intermediate file 43A corresponding to the selected photomovie from the intermediate file database 43. Then, the automatic playback control module 325 outputs the read intermediate file 43A to the moving image data generating module 326.

The moving image data generating module 326 generates moving image data, based on the intermediate file 43A output from the automatic playback control module 325. Specifically, the moving image data generating module 326 generates moving image data, based on image file information, effect information, transition information, and sound file information included in the intermediate file 43A. The detailed processing of moving image data generation is the same as the moving image data generation processing in the interactive playback mode described above. The automatic playback control module 325 may automatically (successively) determine photomovies to be played back, while the moving image player application 202 is operated. That is, the moving image player application 202 may automatically (successively) play back photomovies when it operates in the automatic playback mode.

In addition, the moving image data generating module 326 may generate moving image data (photomovie), based on respective file paths of selected one or more still images, sound data, effect data, and transition data, and parameters (sound parameters, effect parameters, and transition parameters) corresponding to the respective data items, which are output from the interactive creation module 321 or the automatic creation module 322. In such a case, the moving image generating module 326 generates moving image data, based on information indicating the file paths and the parameters output from the interactive creation module 321 or the automatic creation module 322, and the intermediate file creation module 323 generates an intermediate file 43A, based on information indicating the file paths and the parameters. Specifically, it is possible to play back a photomovie based on conditions designated by the interactive creation module 321 or the automatic creation module 322, and generate and store an intermediate file 43A which corresponds to the photomovie. The intermediate file 43A is used when the photomovie is played back again.

The player module 327 plays back the moving image data (photomovie) generated by the moving image data generating module 326. The player module 327 displays the played back moving image data on the screen of the LCD 17.

The playback history managing module 328 stores history information data indicating moving image data (photomovie) played back by the player module 327. The playback history managing module 328 records the history information data in the playback history information data 44A stored in the playback information database 44. For example, in response to finish of playback of a photomovie by the player module 327, the playback history managing module 328 stores a history information data item indicating the photomovie. In addition, the playback history managing module 328 stores, for example, history information data items of a predetermined number of photomovies having the newer playback dates, among a plurality of played back photomovies. Specifically, the playback history managing module 328 successively deletes history information data items indicating photomovies of the older playback dates, from the playback history information data 44A.

The playback history managing module 328 may store an information item indicating a photomovie designated by the user, as favorite information data item. The playback history managing module 328 records the favorite information data item in favorite information data 44B stored in the playback information database 44. The playback history managing module 328 stores a favorite information data item indicating a designated photomovie, in response to instructions by the user through the operation screen.

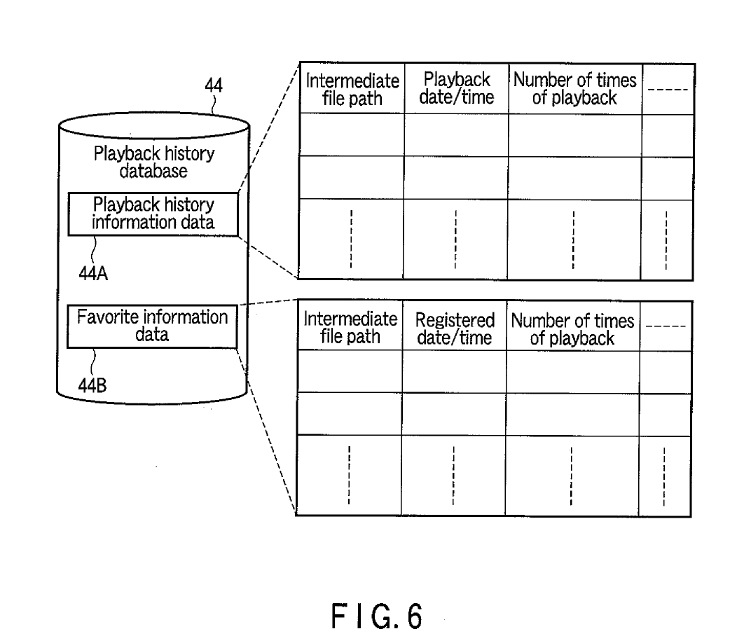

FIG. 6 illustrates an example of a structure of the playback history information data 44A and the favorite information data 44B stored in the playback information database 44.

The playback history information data 44A includes items “intermediate file path”, “playback date”, and “the number of times of playback”. The item “intermediate file path” indicates a file path of an intermediate file 43A corresponding to a played back photomovie. The item “playback date” is time information indicating a playback date and time of the photomovie. The item “the number of times of playback” indicates the number of times of playback of the photomovie.

The favorite information data 44B includes items “intermediate file path”, “recording date”, and “the number of times of playback”. The item “intermediate file path” indicates a file path of an intermediate file 43A corresponding to a photomovie designated as favorite. The item “recording date” is time information indicating the date and time when the photomovie was recorded as favorite. The item “the number of times of playback” indicates the number of times of playback of the photomovie.

The interactive playback control module 324 reads the playback history information data 44A from the playback information database 44, and then displays a list of played back photomovies on the screen (LCD 17). The interactive playback control module 324 may display a list of played back photomovies in the order of, for example, the creation date or recording date.

The interactive playback control module 324 detects a selected photomovie from the list of played back photomovies or the list of favorite photomovies, and then reads an intermediate file 43A corresponding to the detected photomovie from the intermediate file database 43. The moving image data generating module 326 generates moving image data, based on the read intermediate file 43A. Then, the player module 327 plays back the generated moving image data, and displays it on the screen.

Both a photomovie created in the interactive creation mode and a photomovie created in the automatic creation mode may be created, based on conditions which change according to change of the creation date, or conditions determined at random. In addition, new still images 51 may be added to the content database 41 at any time. Therefore, the moving image player application 202 probably creates a different photomovie for each instance of creation. In other words, it may be difficult for the moving image player application 202 to create the same photomovie, even when the user designates the same creation conditions. Therefore, when the user wishes to play back a photomovie which has been once played back again, it may be desirable to find the photomovie from a plurality of photomovies. However, finding a desired photomovie may be difficult when a number of photomovies have been created, such as when photomovies are created in the automatic creation mode.

Therefore, the moving image player application 202 of the present embodiment stores playback history of photomovies as the playback history information data 44A as described above, and presents the user with a list of photomovies based on the playback history information data 44A. Thereby, the user can easily find a photomovie played back recently. In addition, the moving image player application 202 stores photomovies designated by the user as “favorite” in the favorite information data 44B, and presents the user with a list of photomovies based on the favorite information data 44B. Thereby, the user can easily find a favorite photomovie. Display of a list of photomovies using the playback history information and the favorite information is particularly effective in the case where a number of photomovies are created, such as the case where photomovies are automatically and successively created from the still images 51 stored in a storage device such as the HDD 109 and played back.

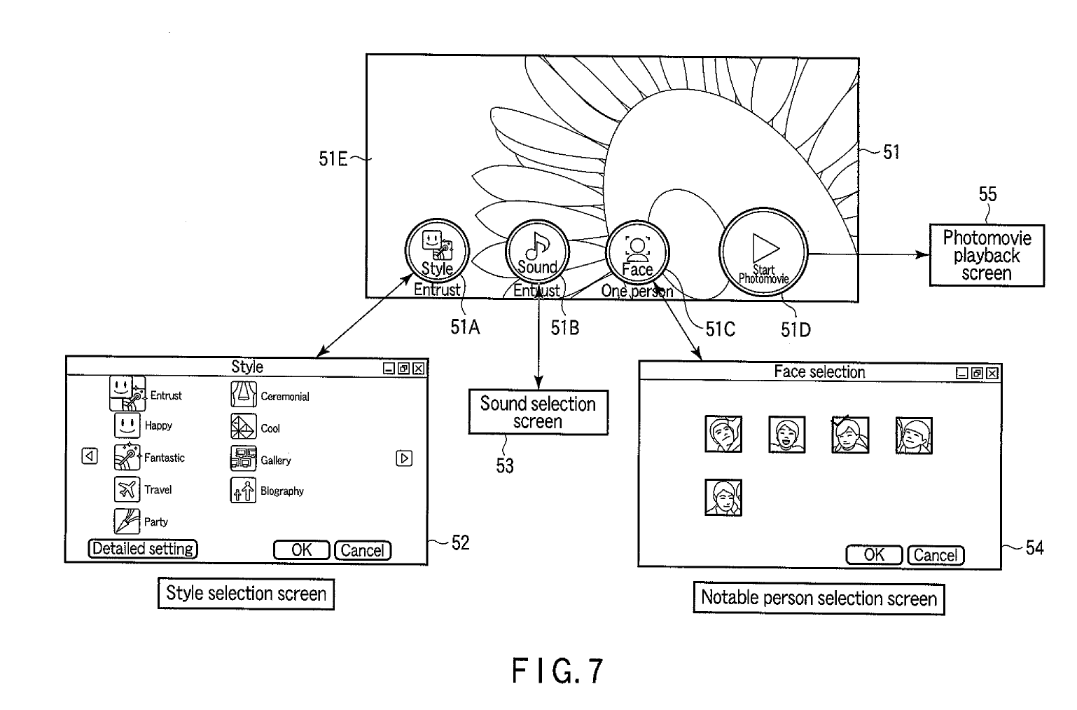

FIG. 7 illustrates an example of an interactive photomovie creation screen 51, which is displayed by the moving image player application program 202 (interactive creation module 321). The user designates creation conditions of a photomovie, by using the interactive creation screen 51. The interactive creation screen 51 includes a style selection button 51A, a sound selection button 51B, a person selection button 51C, a photomovie playback button 51D, and a preview area 51E (a background part in the interactive creation screen 51).

In the example of the interactive creation screen 51 illustrated in FIG. 7, one still image displayed on the preview area 51E is selected. The user may further select still images used for a photomovie. In addition, the moving image player application 202 (interactive creation module 321) may select still images relating to the selected still image from the still images 51.

The moving image player application 202 moves to a style selection screen 52, in response to pressing (click) of the style selection button 51A. In the style selection screen 52, the user selects a style suitable for the photomovie, such as “Ceremonial” and “Happy”. The moving image player application 202 determines effects and transition to which selected one or more still images are subjected, in accordance with the selected style. In addition, the moving image player application 202 may determine sound data used for the photomovie, in accordance with the selected style.

The moving image player application 202 moves to a sound selection screen 53, in response to pressing of the sound selection button 51B. In the sound selection screen 53, the user selects sound data used as BGM of the photomovie. The moving image player application 202 determines the selected sound data as BGM of the photomovie.

The moving image player application 202 moves to a notable person selection screen 54, in response to pressing of the person selection button 51C. In the notable person selection screen 54, the user selects a notable person. For example, the user selects the notable person from a list of face images. The moving image player application 202 can select one or more still images to be used for the photomovie, based on the selected person. The moving image player application 202 can also determine effects and transition used for the still images, such that the selected person attracts attention.

The moving image player application 202 moves to a photomovie playback screen 55, in response to pressing of the photomovie playback button 51D. In the photomovie playback screen 55, a photomovie, which is created based on conditions selected in the interactive creation screen 51, the style selection screen 52, the sound selection screen 53, and the notable person selection screen 54, is played back. Specifically, the moving image player application 202 generates an intermediate file 43A describing information of one or more still images 51, sound data 41A, effect data 41B, transition data 41C, which are selected in accordance with the conditions designated in the interactive creation screen 51 and the like, and parameters relating to these data items. Then, the moving image player application 202 generates moving image data based on the intermediate file 43A. The moving image player application 202 plays back the generated moving image data, and displays it on the photomovie playback screen 55. Thereby, the user can view a photomovie created based on conditions designated in the interactive creation screen 51 and the like.

The moving image player application 202 may play back a photomovie (moving image) based on one or more still images 51, sound data 41A, effect data 41B, transition data 41C, which are selected in accordance with the conditions designated in the interactive creation screen 51 and the like, and parameters relating to these data items. That is, the moving image player application 202 plays back a photomovie and generates an intermediate file 43A, based on one or more still images 51, sound data 41A, effect data 41B, transition data 41C, and parameters relating to these data items.

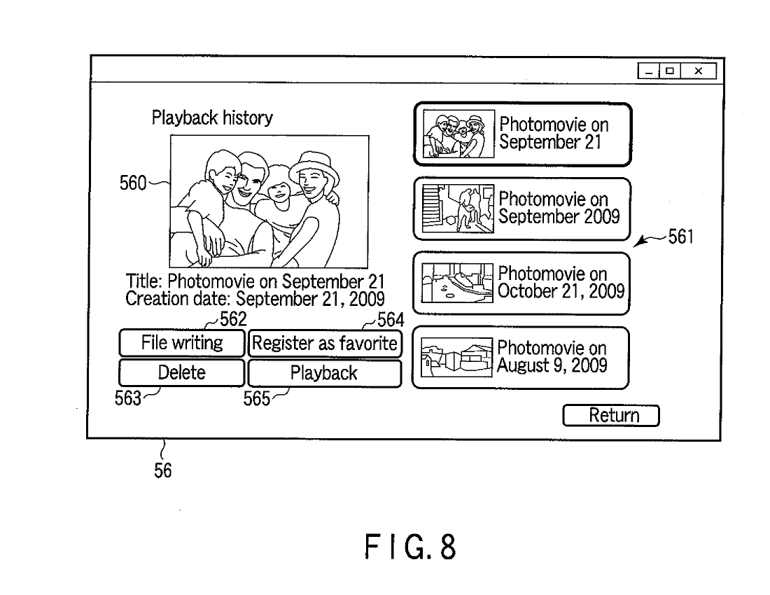

FIG. 8 illustrates an example of a photomovie playback history screen 56, which is displayed by the moving image player application 202 (interactive playback control module 324). As described above the interactive playback control module 324 reads the playback history information data 44A from the playback information database 44, and displays the playback history screen 56 based on the playback history information data 44A. The playback history screen 56 includes a preview area 560, a photomovie playback history list 561, a file writing button 562, a delete button 563, a favorite registration button 564, and a playback button 565. In the photomovie playback history list 561, a list of buttons indicating respective played back photomovies is displayed. Each button displays a title, a representative thumbnail image, a creation date, and information of an appearing person (such as the name and a face image) of a corresponding photomovie. In response to the user's pressing (for example, clicking by a mouse or the like) a button 561 corresponding to a photomovie to be played back from the list and selecting the playback button 565, the moving image data generating module 326 generates moving image data, based on an intermediate file 43A corresponding to the selected photomovie. Then, the player module 327 plays back the generated moving image data, and displays it on the preview area 560. The interactive playback control module 324 may display a representative thumbnail image of the selected photomovie on the preview area 560.

In response to the user's pressing a button 561 corresponding to a photomovie to be written out from the list and pressing the file writing button 562, the moving image data generating module 326 generates moving image data based on a intermediate file 43A corresponding to the selected photomovie. Then, the moving image data generating module 326 creates a moving image data file of the photomovie by converting the generated moving image data into a predetermined format.

In addition, in response to the user's pressing a button 561 corresponding to a photomovie to be deleted from the list and pressing the delete button 563, the playback history managing module 328 deletes a history information data item corresponding to the selected photomovie from the playback history information data 44A. In addition, the selected photomovie is deleted from the playback history list. The selected photomovie itself may be deleted. In such a case, an intermediate file 43A corresponding to the selected photomovie is deleted from the intermediate file database 43.

In addition, in response to the user's pressing a button 561 corresponding to a photomovie to be registered as favorite from the list and pressing the favorite registration button 563, the playback history managing module 328 registers a favorite information data item corresponding to the selected photomovie in the favorite information data 44B. The interactive playback control module 324 reads the favorite information data 44B from the playback information database 44, and displays a list of favorite photomovies on the screen, in the same manner as the photomovie playback history list.

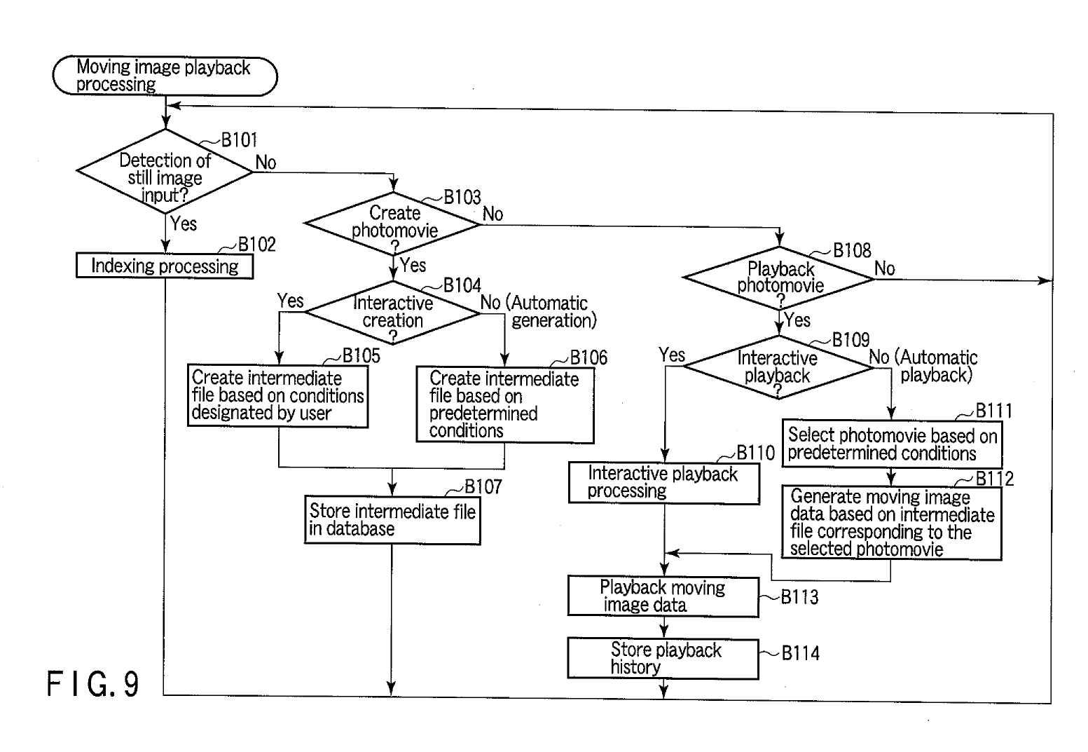

Next, an example of a process of moving image playback processing executed by the moving image player application program 202 will now be explained with reference to a flowchart of FIG. 9.

First, the moving image player application program 202 determines whether input of a still image is detected (block B101). For example, the moving image player application program 202 detects whether a new still image is input by monitoring a directory in which still images are stored. In addition, the moving image player application 202 determines whether a new still image is input, in response to, for example, connection of an external device (digital camera, memory card) in which still images are stored, via the interface section (such as the USB controller 111A and the card controller 111B).

When input of a still image is detected (YES in block B101), the moving image player application program 202 subjects the input still image to indexing processing (block B102). The moving image player application program 202 analyzes the input still image, and then stores information relating to a face image included in the still image, information relating an event corresponding to the still image, and information of a group to which the still image belongs, in the content information data 42A.

When no input of a still image is detected (NO in block B101), the moving image player application program 202 determines whether creation of a photomovie is requested (block B103). When creation of a photomovie is requested (YES in block B103), the moving image player application program 202 determines whether creation by the interactive creation mode is requested (block B104). Specifically, the moving image player application program 202 determines which of creation by the interactive creation mode and creation by the automatic creation mode is requested.

When creation by the interactive creation mode is requested (YES in block B104), the moving image player application program 202 creates an intermediate file 43A corresponding to a photomovie, based on conditions designated by the user (block B105).

When creation by the interactive creation mode is not requested (that is, when creation by the automatic creation mode is requested) (NO in block B104), the moving image player application program 202 creates an intermediate file 43A corresponding to a photomovie, based on predetermined conditions (block B106).

Then, the moving image player application program 202 stores the intermediate file 43A created in block B105 or block B106 in the intermediate file database 43 (block B107). When the intermediate file 43A is created in the interactive creation mode, the moving image player application program 202 may play back moving image data based on the created intermediate file 43A by moving to the interactive playback mode. In addition, when the intermediate file 43A is created in the automatic creation mode, the moving image player application program 202 may play back moving image data based on the created intermediate file 43A by moving to the automatic playback mode. Besides, when the intermediate file 43A is created in the interactive creation mode based on conditions designated by the user, the moving image player application program 202 may play back moving image data based on the conditions designated by the user, that is, based on information indicating file paths and parameters of data used for the photomovie. In addition, when the intermediate file 43A is created in the automatic creation mode based on predetermined conditions, the moving image player application program 202 may play back moving image data based on the predetermined conditions, that is, based on information indicating file paths and parameters of data used for the photomovie.

When creation of a photomovie is not requested (NO in block B103), the moving image player application program 202 determines whether playback of a photomovie is requested (block B108). When playback of a photomovie is requested (YES in block B108), the moving image player application program 202 determines whether playback by the interactive playback mode is requested (block B109). Specifically, the moving image player application program 202 determines which of playback by the interactive playback mode and playback by the automatic playback mode is requested.

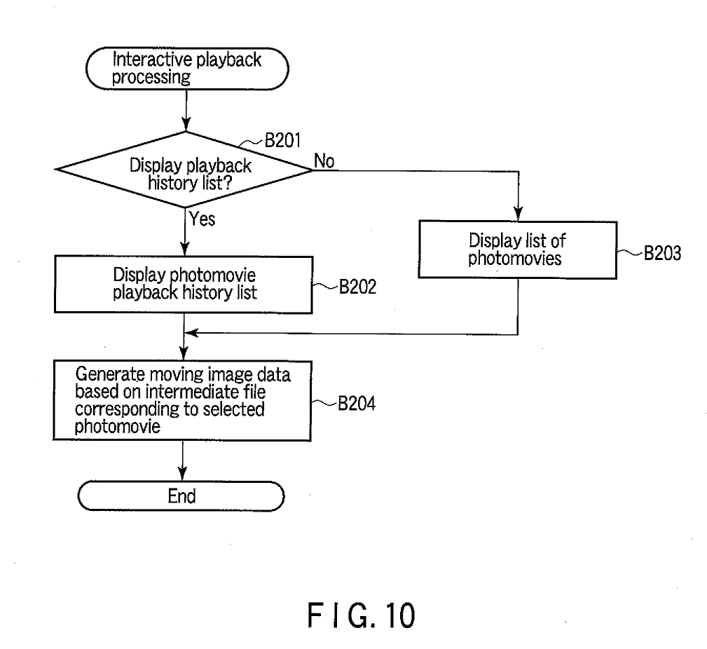

When playback by the interactive playback mode is requested (YES in block B109), the moving image player application program 202 executes interactive playback processing (block B110). The moving image player application program 202 generates moving image data based on an intermediate file 43A corresponding to the photomovie selected by the user. The details of the interactive playback processing will be described later with reference to a flowchart of FIG. 10.

When playback by the interactive playback mode is not requested (that is, when playback by the automatic playback mode is requested) (NO in block B109), the moving image player application program 202 selects a photomovie based on predetermined conditions (block B111). According to the predetermined conditions, for example, a photomovie having a newer creation date (newly-arrived photomovie) or a photomovie corresponding to an event relating to the date of playback (the current date) (for example, when tomorrow is a person's birthday, a photomovie of the person's birthday last year) is selected. The moving image player application program 202 generates moving image data, based on an intermediate file 43A corresponding to the selected photomovie (block B112).

Thereafter, the moving image player application program 202 plays back the moving image data created in block B110 or block B112, and displays it on the screen (block B113). Then, the moving image player application program 202 stores a history information data item 44A indicating the played back photomovie in the playback information database 44 (block B114).

By the above processing, the moving image player application program 202 can perform indexing for the input still image, creation of a photomovie by the interactive creation mode or the automatic creation mode, and playback of a photomovie by the interactive playback mode or the automatic playback mode.

Next, an example of a process of interactive playback processing executed by the moving image player application program 202 will now be explained with reference to the flowchart of FIG. 10.

First, the moving image player application program 202 determines whether display of the photomovie playback history list (playback history screen 56) is requested or not (block B201). A request to display the playback history screen 56 is input, for example, by operation by the user.

When display of the playback history screen 56 is requested (YES in block B201), the moving image player application program 202 reads the playback history information data 44A from the playback information database 44, and displays the photomovie playback history list on the screen (block B202). The user selects a photomovie to be played back from the displayed photomovie playback history list.

On the other hand, when display of the playback history screen 56 is not requested (NO in block B201), the moving image player application program 202 displays a list of created photomovies on the screen (block B203). In addition, the moving image player application program 202 displays a list of photomovies which satisfy conditions designated by the user, such as the date (period of time), appearing person, and event, on the screen. The user selects a photomovie to be played back from the displayed list of photomovies.

Then, the moving image player application program 202 reads an intermediate file 43A corresponding to the selected photomovie from the intermediate file database 43, and generates moving image data based on the read intermediate file 43A (block B204). The generated moving image data is played back, and the user can view the photomovie selected from the list of photomovies or the photomovie playback history list.

As described above, according to the present embodiment, moving images created by using one or more images can efficiently be managed. The moving image player application program 202 of the present embodiment generates an intermediate file 43A describing information indicating one or more still images 51 and sound data 41A which are used for a photomovie, and effect data 41B and transition data 41C to which the still images are subjected. Then, moving image data for actually playing back the photomovie is created based on the intermediate file 43A, when playback of the photomovie is requested. Thereby, it becomes unnecessary to store moving image data itself having a large data quantity, and it is possible to reduce the data quantity required for storage of a photomovie.

In addition, for example, when a number of photomovies are created, it is difficult to find a desired photomovie from the photomovies. Therefore, the moving image player application program 202 displays a list of photomovies, based on playback history information and favorite information of photomovies. Thus a user can easily find a desired photomovie.

All the procedures of the moving image playback process in this embodiment may be executed by software. Thus, the same advantageous effects as with the present embodiment can easily be obtained simply by installing a program, which executes the procedures of the moving image playback process, into an ordinary computer through a computer-readable storage medium which stores the program, and executing this program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a first playback module configured to generate a moving image, the moving image comprising one or more still images respectively displayed at stored display timings;
a moving image information data creating module configured to create moving image information data indicating respective locations where the one or more still images used for the moving image are stored and indicating the stored display timings;
a display module configured to generate a playback history list of moving images generated by the first playback module; and
a second playback module configured to generate a moving image selected from the playback history list based on at least some of the moving image information data corresponding to the selected moving image.

2. The electronic apparatus of claim 1, wherein the at least some of the moving image information data used by the second playback module comprises the stored display timings.

3. The electronic apparatus of claim 1, wherein the first playback module is configured to generate a moving image in which the one or more still images are subjected to effects,
wherein the moving image information data indicates the effects to which the one or more still images are respectively subjected, and
wherein the second playback module is configured to generate a moving image in which the one or more still images are respectively subjected to the effects, based on the moving image information data.

4. The electronic apparatus of claim 1, wherein the moving image information data indicates a proper effect which is selected in accordance with face information of faces detected by face detection for each of the one or more still images and indicates motion information to attract attention to the faces.

5. The electronic apparatus of claim 1, wherein the first playback module is configured to generate a moving image in which sounds are respectively output at stored output timings,
the moving image information data indicates the sounds and the output timings, and
the second playback module is configured to generate the moving image in which the sounds are output at the output timings.

6. The electronic apparatus of claim 1, wherein the one or more still images comprise a still image selected at random from multiple still images.

7. The electronic apparatus of claim 1, wherein the one or more still images comprise a still image including a face image of a selected person.

8. The electronic apparatus of claim 1, wherein the one or more still images comprise a still image created on a selected date or in a selected period.

9. An image processing method comprising:
displaying a moving image a first time, the moving image comprising one or more still images respectively displayed at stored display timings;
creating moving image information data indicating respective locations where the one or more still images used for the moving image are stored and indicating the stored display timings;
displaying a playback history list of moving images played back by the playing back the first time; and
displaying a second time a moving image selected from the playback history list based on moving image information data corresponding to the selected moving image.

10. A non-transitory computer-readable storage medium storing computer-executable instructions that, when executed, cause the computer to:
display a moving image a first time, the moving image comprising one or more still images respectively displayed at stored display timings;
create moving image information data indicating respective locations where the one or more still images used for the moving image are stored and indicating the stored display timings;
display a playback history list of moving images played back the first time; and
display a second time a moving image selected from the playback history list based on moving image information data corresponding to the selected moving image.

11. The computer-readable storage medium of claim 10, wherein causing the computer to display a second time the selected moving image comprises causing the computer to display a moving image in which the one or more still images are respectively displayed at the stored display timings, based on moving image information data corresponding to the selected moving image.

12. The computer-readable storage medium of claim 10, wherein causing the computer to display the moving image the first time comprises causing the computer to display a moving image in which the one or more still images are subjected to effects,
wherein the moving image information data indicates the effects to which the one or more still images are respectively subjected, and
causing the computer to display a second time the selected moving image comprises causing the computer to display a moving image in which the one or more still images are respectively subjected to the effects based on the moving image information data.

13. The computer-readable storage medium of claim 10, wherein the moving image information data indicates a proper effect which is selected in accordance with face information of faces detected by face detection for each of the one or more still images, and indicates motion information to attract attention to the faces.

14. The computer-readable storage medium of claim 10, wherein causing the computer to display a first time the moving image comprises causing the computer to display a moving image in which sounds are respectively output at stored output timings,
the moving image information data indicates the sounds and the output timings, and
causing the computer to display a second time the selected moving image comprises causing the computer to display the moving image in which the sound is output at the output timing.

15. The computer-readable storage medium of claim 10, wherein the one or more still images comprise a still image selected at random from multiple still images.

16. The computer-readable storage medium of claim 10, wherein the one or more still images comprise a still image including a face image of a selected person.

17. The computer-readable storage medium of claim 10, wherein the one or more still images comprise a still image created on a selected date or in a selected period.
